(19) United States
(12) Patent Application Publication
(10) Pub. No.: US 2006/0107226 A1
(43) Pub. Date: May 18, 2006

(54) Sidebar autohide to desktop

(75) Inventors: David A. Matthews, Seattle, WA (US); Mark R. Ligameri, Snohomish, WA (US); Charles Cummins, Seattle, WA (US); Jeffrey W. Pettiross, Seattle, WA (US); Yeming Shi, Pittsburgh, PA (US); Charles W. Stabb, Seattle, WA (US); Fabrice A. Debry, Bellevue, WA (US); Andrew S. Crane, Seattle, WA (US); Hillel N. Cooperman, Sammamish, WA (US)

Correspondence Address: BANNER & WITCOFF LTD.,;ATTORNEYS FOR MICROSOFT, 1001 G STREET , N.W., Suite 1100, WASHINGTON, DC, 20001-4597, US

(73) Assignee: Microsoft Corporation, Redmond, WA (US)

(21) Appl. No.: 10/988,595

(22) Filed: Nov. 16, 2004

(51) Int. Cl. G06F 17/00

(52) U.S. Cl. 715/766

(57) ABSTRACT

The present invention provides a system and method for convenient display of a user interface providing dynamic information. The user interface may contain a designated area that provides the dynamic information and a predetermined location. When a cursor hovers over the predetermined location, the user interface may be displayed in front of any overlapping element on the display. The user interface may be displayed behind the overlapping elements on the display when the cursor is moved away from the user interface or predetermined location.

### FIELD OF THE INVENTION

The present invention relates to displaying an organization of dynamic information in a computer system and, in particular, efficiently displaying the organization of dynamic information in conjunction with displaying other information as necessary.

### BACKGROUND OF THE INVENTION

Computer users have struggled with the need for easy access to information while performing tasks on the computer. The information may include dynamic information that the user might wish to track. For example, the user may wish to keep abreast of late-breaking news, stock quote information or the latest weather or sports reports. Traditionally, when a user desires such information while performing a task on the computer, the user would have to temporarily suspend the performance of the task to perform various manipulations on the computer to obtain the desired information. This results in delays in completing the main task as well as inconvenience and frustration for the user.

At the same time, a computer user has only a finite amount of space on the display within which to complete the performance of desired tasks. While performing the tasks, the user may wish to access dynamic information, however, there may be insufficient space on the display to provide the dynamic information while simultaneously maintaining the documents or windows necessary to perform the task. Traditionally, additional information was displayed only at the cost of losing active or visual access to other information, windows or displays or losing a portion of the workspace necessary to perform the primary task. In this way, the user was unable to conveniently perform the computer task while simultaneously obtaining access to additional information.

Thus, there exists a need in the art for a system and method for accessing information, such as dynamic information, while maintaining a computer workspace for performing computer tasks in a convenient, time-saving manner.

### SUMMARY OF THE INVENTION

The system and method enables the user to efficiently perform desired computer tasks while also achieving access to desired information without the inconvenience and frustration of a loss of access to displayed information or loss of workspace.

In one aspect of the present invention, a user interface is provided on a display with a display element, each of the user interface and the display element having an associated Z-order value. In this example, the user interface is displayed behind the overlapping element. The Z-order value of the user interface is set to a value higher than the Z-order value of the display element responsive to receiving a command to change the relative Z-order values. The user interface may be displayed in front of the display element. Further in this example, a command to set the Z-order value of the user interface to a value lower than the Z-order value of the display element may be received. In one embodiment, the predetermined location is on a taskbar. The user interface may be displayed at any location on the display. For example, the user interface may be displayed at a side edge of the display.

In another aspect of the present invention, the user interface provides dynamic information which includes but is not limited to financial information, weather information, sports information, news information, auction information and buddy list information.

In another aspect of the present invention, a command to change the relative Z-orders of the user interface and the display element comprises hovering a cursor over a designated area in the user interface and activating a cursor over the designated area. For example, a user may click a mouse button over the designated area causing the user interface to be displayed in front of the overlapping element. Additionally, the Z-order value of the designated area may be higher than the Z-order value of the display element until further action is taken, such as clicking a button or icon or selecting an option from a menu.

In another aspect of the present invention, the user interface is displayed in front of the overlapping element only after the cursor hovers over a predetermined location in the user interface for a predetermined period of time. For example, a delay may be present such that the user interface is not immediately displayed in front of the overlapping element when the cursor is moved over the predetermined location. Rather, the user interface is displayed in front of the overlapping element only after the cursor hovers over the predetermined location for a specified period of time. In this example, accidental display of the user interface in front of the overlapping element is prevented.

In another aspect of the present invention, after the user interface is displayed in front of the overlapping element, the user interface may then be displayed behind the overlapping element after the cursor is moved away from the predetermined location for a predetermined period of time. In this example, accidental display of the user interface behind the overlapping element is avoided. In this example, accidental dismissal of the user interface is prevented.

In another aspect of the present invention, a graphical user interface is provided with a Z-order value that is higher than other display elements on the display if a command to set the Z-order value higher is received. In another example, the graphical user interface is displayed in front of other display elements responsive to the command to set the Z-order value higher than the Z-order value of the other display elements. The command may be hovering a cursor over a predetermined location, activating the cursor over a designated area or receiving at least one keyboard stroke input, for example. In another example, the graphical user interface may be displayed behind the other display elements if a command is received for setting the Z-order value of the graphical user interface to a lower value than the Z-order value of the other display elements.

In another aspect of the present invention, the graphical user interface or the designated area is smaller than the height and width of the display.

### BRIEF DESCRIPTION OF THE DRAWINGS

FIG. 1 illustrates an example of a system for implementing the invention which includes a general purpose computing device in the form of a computer.

FIGS. 2A-2C illustrate an example of an aspect of the invention in which access to information or information source interfaces in the designated area is provided by situating the designated area in front of other windows or applications.

FIGS. 3A-3C illustrate an example of another aspect of the present invention in which access to information contained in a designated area is provided if there are no interfering windows or applications on a display.

FIGS. 4A-4B illustrate an example of another aspect of the present invention in which a designated area may be made to be accessible when other elements obscure the designated area and block immediate access to information in the designated area.

FIG. 5 is an enlarged view of the bottom right corner of the display of FIGS. 4A and 4B and illustrates one example of a method of bringing the designated area to the front of the display.

FIGS. 6A-6C illustrate an example of an alternative method of achieving fast access to a designated area on a display when the designated area is partially obscured by a display element such as a window.

FIGS. 7A-7C illustrate an example of an aspect of the present invention in which a user easily and conveniently dismisses a designated area.

FIGS. 8A-8D illustrate an example of an aspect of the present invention in which a designated area is invoked and dismissed.

FIG. 9 illustrates an example of the present invention of providing for a delay in causing the designated area to appear on the display in front of other elements on the display.

### DETAILED DESCRIPTION

Aspects of the present invention provide a system and method of managing information on a display such that a user may perform a task while simultaneously accessing desired information, including dynamic information, in an efficient manner. For example, a user may perform a desired task on a computer while also desiring updated information from the computer. The desired information may include dynamic information in which the information is frequently updated. Also, the desired information, such as the dynamic information, may be provided via information source interfaces in a designated area of the display. Examples of such information include but are not limited to stock quote information, weather forecast information, sports results, news events, auction results and status, buddy lists, etc. The present invention provides for a designated area on a display for providing user access to the updated information and information source interfaces as desired.

The designated area may be located at any position on the display, including but not limited to one of the side edges of the display, the bottom edge, top edge, or anywhere on the display based on the needs or preferences of the user. The designated area may further be located on an additional monitor or display. For example, more than one monitor or display may be used with the designated area being displayed on any one or combination of monitors or displays. In one embodiment, the designated area is a sidebar on a side of the display. In another embodiment, the designated area is located in the middle of a display. The location of the designated area may further be altered by toggling the designated area between 2 or more locations. For example, if the designated area is at the bottom of the display, the user may toggle the designated area between the bottom of the display and the top of the display. Likewise, the user may wish to toggle the designated area between the bottom and top of the display and a third (or fourth, fifth, etc.) location such as the side of a display (or other location) or at any location on any additional display. Toggling of the designated area may be accomplished in a variety of ways. For example, toggling may be accomplished by activating a button in the designated area, by moving a cursor over a predetermined location on the display or by using shortcut keys.

Also, the designated area may be in any shape as desired by the user. Typically, the designated area may be a delineated, circumscribed, rectangular region for providing desired information such as dynamic information as described. However, the present invention is not so limited. The designated area may also take any number of forms. For example, the designated area may be non-rectangular such as circular, ovoid, triangular, polygonal, trapezoidal, irregularly-shaped, in the shape of an object or personality, or even amorphous. Moreover, although the designated area may be well-delineated for clarity, for example, by lines, drop shadows or any designs, the designated area need not be limited to being a well-delineated area. For example, in one aspect of the present invention, the designated area is “invisible” such that there are no outlines delineating the borders of the designated area. Additionally, the designated area may appear “invisible” in that the information source interfaces or tiles in the designated area appear to be located directly on the desktop rather than in a designated area. However, even though the designated area is not visible in this example, the information source interfaces or tiles in the designated area behave as described for the designated area.

In one example, the designated area on the display contains information source interfaces that provide the user with access to desired information. The designated area may be displayed while other application windows are being displayed. For example, a user may be performing a computer task in an application window being displayed while also desiring dynamic and updated information from an application in the designated area. If the application window overlaps the designated area, information in the designated area may be obscured. In this situation, the user may not have easy access to the desired information contained in the designated area.

In the display of the designated area, windows, and desktop, the operating system uses a simulated three-dimensional layering system to display the designated area and other display elements drawn in a two dimensional graphical space, referred to as “Z-ordering.” The term Z-order is derived from three dimensional (3D) geometry, where the horizontal axis is typically known as the X-axis, the vertical axis is the Y-axis, and the Z axis sits perpendicular to the plane formed by the X and Y axes. Hence, the Z-order value for each display element (e.g., windows) refers to the relative position along an axis perpendicular to the desktop (the Z axis) that the element occupies. Z-ordering is used to draw the two dimensional display by determining which of two or more overlapping display elements is displayed in front. Determination of which display element of two or more overlapping display elements is displayed in front is determined by the relative Z axis coordinates or Z-order values of the display elements which in turn depend on the orientation of the origin of the X, Y and Z axes relative to the positioning of the display elements. For example, if the Z axis is oriented such that coordinates on the Z axis or Z-order values increase as the Z axis projects out of the screen, then display elements with higher (more positive) Z-order values are displayed in front of other display elements with lower (less positive) Z-order values. Likewise, if the Z axis is oriented such that coordinates on the Z axis or Z-order values increase as the Z axis projects into the screen, then display elements with higher (less negative) Z-order values are displayed in front of other display elements with lower (more negative) Z-order values.

In this example, the designated area may be displayed at a higher Z order as compared to the application window when the user causes the designated area to be displayed as such but is displayed at a lower Z order than the application window if the user does not cause the designated area to be displayed at a higher Z order or at the top of the Z order. By displaying the designated area at the higher Z order only when the user requests or causes the designated area to be displayed, interference between the designated area and the other information or application windows being displayed is minimized. The user may cause the designated area to be displayed based on Z order values in many ways. For example, the user may input a command to display the designated area either at the top of the Z order or at a higher Z order than other display elements such that the designated area is displayed in front of the other display elements. The command to change the Z order of the designated area in relation to the Z order of the other display elements may include but is not limited to hovering a cursor over a predetermined location, placing the cursor against an edge of the screen, selecting a button, selecting a command from a menu, or using shortcut keys (e.g., a predetermined keyboard stroke or combination of keyboard strokes).

In one example, the command to change the relative Z-order values of the designated area and the other display elements is provided by hovering the cursor over a predetermined location. The predetermined location may be present, for example, on the designated area, on the taskbar, or at any predetermined location on the display. Preferably, the predetermined location is a small, contained area such that the risk of accidental activation of the designated area is minimized. For example, the predetermined location may be a small, contained area in a corner of the display or the predetermined location may be an area on the display such that the greatest dimension of the predetermined location is less than the width or height of the display itself. Preferably, the greatest dimension of the predetermined location is substantially less than the width or height of the display. By limiting the size and/or location of the predetermined location, a user may be assured that accidental invocation of the designated area and subsequent unwanted obscuring of any other display elements on the display is avoided.

In another example, the designated area may be minimized to the taskbar in order to more efficiently utilize the workspace. In this example, the designated area is minimized to a button on the taskbar. The button on the taskbar may additionally contain small icons of the applications in the designated area. When the user desires the information in the designated area, the user may maximize the designated area such that the designated area is displayed. When the user no longer desires the information in the designated area, the user may minimize the designated area to the taskbar again.

In another example of the present invention, the designated area may be at the top of the Z order (e.g., the Z-order value of the designated area may be higher or more positive than the Z-order value of other display elements) on the display and may consequently rest in front of all other elements displayed on the display. In this example, the information and information source interfaces contained in the designated area is available to the user regardless of the status of the other information such as images, icons or windows in the remainder of the display (e.g., the general desktop). In this example, a maximized window with a lower Z-order value and hence, a lower Z order, than the designated area would be displayed adjacent to the designated area if situated beside the designated area on the general desktop while a similar window overlapping the designated area but with a lower Z-order value than the designated area would be displayed behind the designated area. Hence, in this example, the designated area would not be covered by the maximized window and the information and information source interfaces contained within the designated area would be accessible to the user at all times. Also, desktop icons may be placed beside the designated area in this example but not in front of the designated area. If desktop icons are present in the portion of the display in which the designated area is situated, the desktop icons may shift such that the desktop icons do not coincide with the designated area.

In another example of the present invention, the designated area is at a lower Z order than other display elements on the display, i.e., the designated area has a lower (less positive or more negative) Z-order value than other display elements. Thus, the designated area is placed behind other elements on the display. Hence, a maximized window with a higher (more positive or less negative) Z-order value than the designated area and situated beside the designated area would be displayed adjacent to the designated area, however, a window with a higher Z order value than the designated area and overlapping the designated area would be displayed in front of the designated area. In this example, information contained in the designated area might be obscured by the overlapping window. In another embodiment, desktop icons may be placed on a different layer from other display elements such that the desktop icons can be placed beside the designated area but cannot be placed behind the designated area.

In one aspect of the present invention, the designated area has a lower Z-order value than other display elements and is placed behind overlying elements such that a maximized window (with a higher Z-order value than the designated area) overlapping the designated area, for example, would be displayed in front of the designated area. The user may desire access to the designated area or the information and information source interfaces within the designated area even though the maximized window overlaps and obscures the designated area or the information source interfaces in the designated area. In this example, a command may be received to change the Z order of the designated area such that the designated area is brought to the front of the display or to display the designated area in front of the other display elements on the display. The command to increase the Z order of the designated area and display the designated area in front of other display elements may be provided in many ways. For example, a cursor may be placed over or hovered over a predetermined location such that the designated area is brought to the front of the display (e.g., in front of other windows) without otherwise disturbing the placement of the display as a whole. In this example, the command to change the relative Z orders of the designated area and other display elements and to display the designated area is received through the placement of the cursor. Thus, the designated area and the information and information source interfaces contained thereon are conveniently made visible and accessible to the user despite the presence of additional elements on the display that might potentially obscure the designated area. However, there are many alternative ways to provide a command to display the designated area. Non-limiting examples of commands to display the designated area include activating an input device (e.g., click a mouse button) with the cursor over an exposed (i.e., visible) portion of the designated area in order to bring the designated area to the front of the display, selection of commands from a menu or a combination of keyboard strokes, to name a few.

In another aspect of the present invention, the Z-order value of the designated area may be increased above the Z-order value of other display elements such that the designated area may be brought to the front as described such that the user may view the contents of the designated area or have access to any information or information source interfaces present on the designated area. However, if the user no longer desires access to the information or information source interfaces in the designated area, the user may dismiss the designated area. For example, the user may change the Z-order value of the designated area relative to the Z-order values of other display elements. In one embodiment, dismissing the designated area means changing the placement of the designated area by lowering the Z-order value of the designated area such that any overlapping windows or applications may sit in front of the designated area. The designated area may be dismissed, for example, by decreasing the Z-order value of the designated area below that of other display elements. After receiving a command to dismiss the designated area such that the designated area is minimized or the designated area is displayed behind other display elements. Non-limiting examples of commands for decreasing the Z-order value of the designated area to provide for displaying other display elements in front of the designated area (e.g., dismissing the designated area) include clicking in a predetermined area on the display to effect the dismissal of the designated area, moving the cursor out of the visible designated area such that the designated area returns to the bottom element in the display, i.e., the Z-order value of the designated area is decreased (made more negative or less positive) and the designated area is placed behind other display element or becomes obscured by the overlying elements on the display such as maximized windows, selecting a command on a menu to dismiss the designated area or receiving a combination of keyboard strokes.

In another aspect of the present invention, the Z-order value of the designated area may be increased (made more positive or less negative) such that the designated area may be brought to the front of the other elements on the display after a predetermined period of time following receiving a command that increases the Z-order value of the designated area to display the designated area in front of other display elements. An example of a command to display the designated area in front of other display elements includes moving the cursor over a location on the display for bringing the designated area to the front of the display such that the designated area may lie in front of the other elements on the display. In this example, the cursor is placed over the predetermined location and after a predetermined period of time, the designated area is brought to the front of the display. By bringing the designated area to the front of the display only after a predetermined period of time elapses, the designated area remains behind other display elements (i.e., obscured by overlying elements) if the cursor is inadvertently temporarily moved over the location on the display. For example, a user may not wish to access information in the designated area but may move the cursor across the display for other reasons. If the cursor fortuitously passes over a location for bringing the designated area to the front, the user would not wish the designated area to be brought to the front. In this example, the cursor moves over the location for bringing the designated area to the front but does not stay in the location for the predetermined period of time. Therefore, the designated area is not brought to the front of the display. The predetermined period of time can be set based on user preference.

In another aspect of the invention, the location of the designated area is modifiable. For example, the designated area may be located at one location of the display but may be re-located to a different location on the display or on an alternate display. Alternatively, the designated area may span over more than one display such that a portion of the designated area is displayed on one display while another portion of the designated area is displayed on another display. The position of the designated area may be modified in many ways. For example, the user may activate a button in the designated area to cause the designated area to change positions on the display. As an example, the designated area may be at the bottom edge of a display monitor but may be changed to the top edge of the display monitor. A user may activate a button in the designated area to move the designated area.

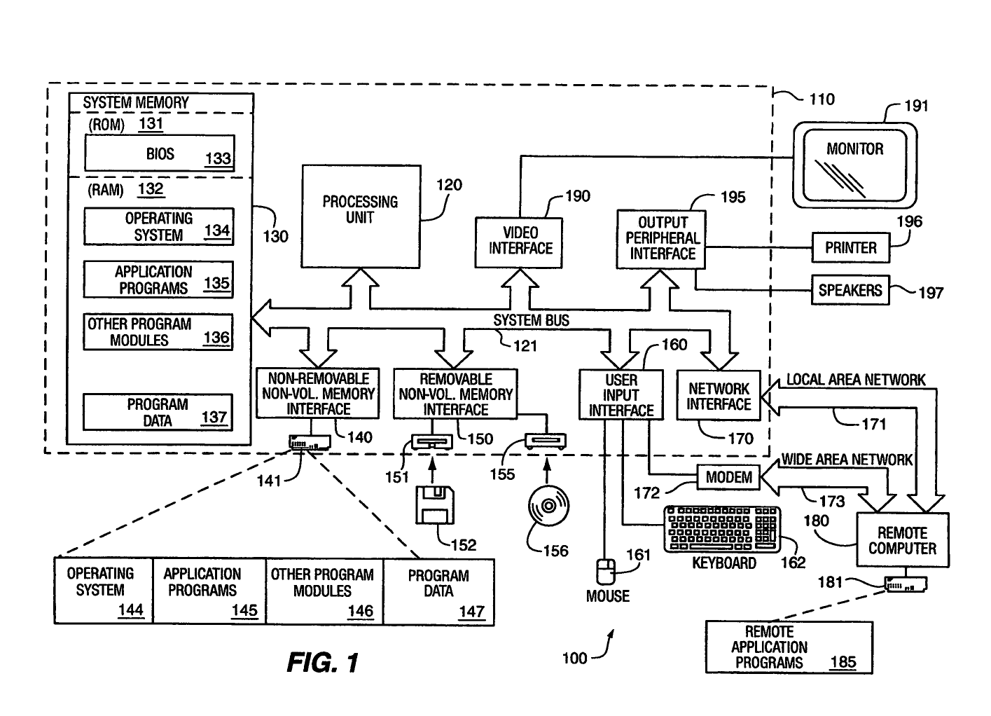

The present invention may be implemented in an operating environment. FIG. 1 illustrates an example of a suitable operating environment 100 in which aspects of the present invention may be implemented. The operating environment 100 is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

With reference to FIG. 1, an illustrative system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media includes both volatile and nonvolatile media, removable and non-removable media. By way of example, and not limitation, computer readable media may comprise computer storage media and communication media and includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

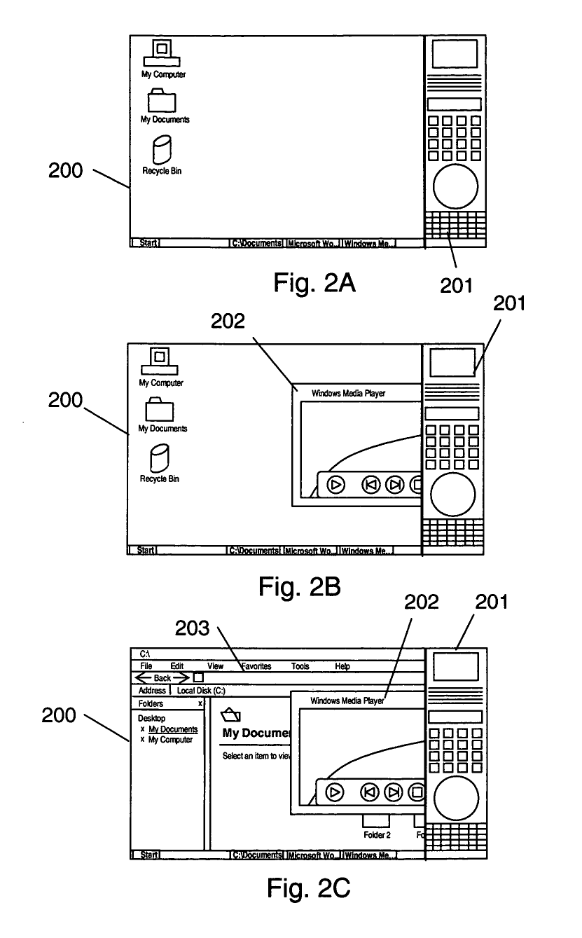

FIGS. 2A-2C illustrate an example of an aspect of the invention in which access to information or information source interface, including dynamic information, in the designated area is provided by situating the designated area in front of other windows or applications. FIG. 2A shows a display 200 with a designated area 201 on the right side of the display in which there are no other open windows. In this embodiment, the designated area 201 covers a column on the right side extending the entire height of the display. Hence, presentation of information in the designated area and information source interfaces is unimpeded.

FIG. 2B illustrates the same display 200 with a window (in this case, a Windows media Player video clip window) 202 opened and arranged to overlap with the designated area 201. In this example, the designated area 201 and the information or information source interfaces contained in the designated area 201 have a higher Z order than other display elements on the display 200. The designated area 201 has a higher Z order than window 202, for example. Thus, the designated area 201 is available for access even though the window 202 and the designated area 201 overlap because the designated area 201 lies in front of the window 202.

Similarly, FIG. 2C illustrates multiple windows 202, 203 over an area in the display 200 in which the designated area 201 resides—in this case, a window 203, which is maximized on the display and occupies substantially all of the display area in this example, and a Windows Media Player video clip window 202. The designated area 201 has a higher (more positive or less negative) Z-order value than the other display elements (e.g., the window 203 and the Windows Media Player video clip window 202) such that the designated area 201 and the information source interfaces in the designated area 201 overlap and are displayed in front of both the window 203 and the Windows Media Player video clip window 202. In this example, a user may maintain access to the information and information source interfaces contained in the designated area 201 even when another window (e.g., 202, 203) is opened on the display 200.

The information source interfaces in the designated area 201 may provide any desired information. For example, the information source interfaces may provide desired dynamic information. Dynamic information includes any information that may be frequently updated. Examples of such information include, but are not limited to, stock or securities information, news or sports information (e.g., sports scores, news updates, late-breaking news, etc.), auction information (e.g., prices of items being auctioned, status of the sale of items, current bid, etc.), weather information (e.g., forecasts, emergency information, weather warnings, etc.), instant messenger information (e.g., buddy lists, contact lists, contact online status, conversation threads), personal information (e.g., meetings, scheduling, e-mail, contacts), etc.

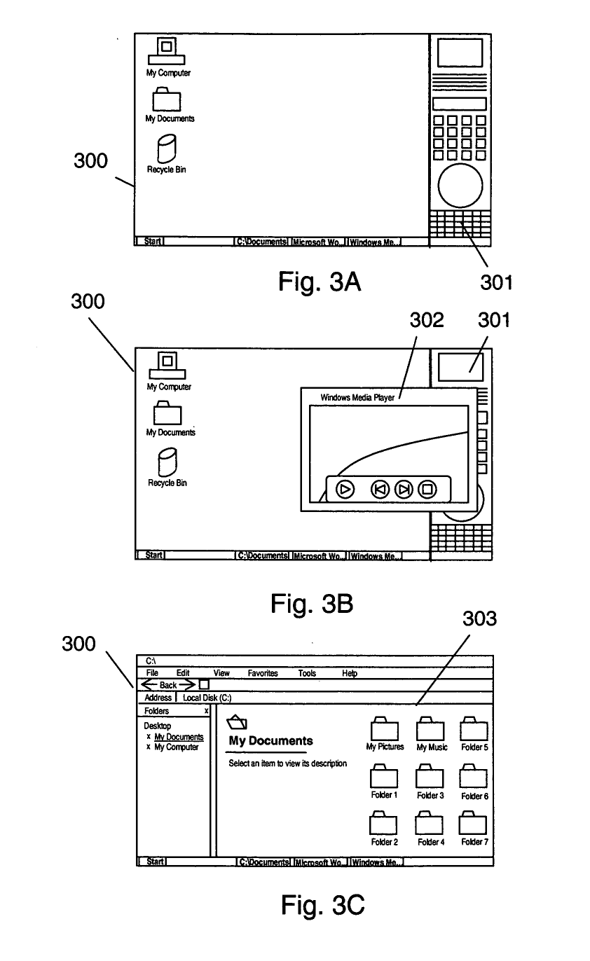

FIGS. 3A-3C illustrate an example of another aspect of the present invention in which access to information or information source interfaces contained in the designated area 301 is provided if there are no interfering windows or applications on the display 300. FIG. 3A shows a display with a designated area 301 that provides dynamic information (as described above) to a user. There are no other elements present on the desktop that interfere with the designated area 301.

However, as illustrated in FIG. 3B, when a window with a higher (more positive or less negative) Z-order value than the designated area (in this case, a Windows Media Player video clip window) 302 is opened on the display 300 and arranged to lie in an area of the display 300 that is occupied by the designated area 301, the window 302 that has the higher Z-order value overlaps the designated area 301 such that a portion of the designated area 301 is obscured by the window 302. In this example, the designated area 301 has a lower Z-order value than the window 302 and therefore the information in the designated area 301 is displayed behind the window 302 and is not readily accessible. If access to the information in the designated area 301 is desired when the window 302 is open, the window 302 must first be moved to expose the underlying information in the designated area 301.

FIG. 3C illustrates a large window 303 on the display 300 that has a higher Z-order value than the designated area (not seen) and completely obscures the designated area (not seen). In this example, the designated area 301 has a lower Z-order value than the overlying window 303 such that the entire designated area 301 is covered by the open window 303 such that none of the information or information source interfaces in the designated area 301 is readily visible or accessible. In this example, the designated area 301 is at the bottom of the Z order of the display 300 in that other display elements have display priority (higher Z-order value) over the designated area 301. Because the other display elements have a higher Z-order value than the designated area 301 and as such have display priority over the designated area 301, even though the designated area 301 is displayed, the other display elements with higher Z-order values than the designated area and that overlie the designated area 301 lie in front of and obscure the designated area 301.

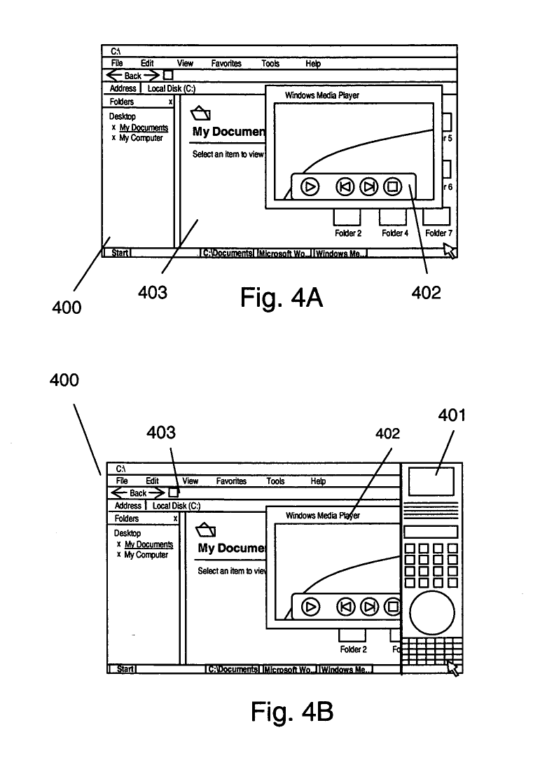

In another example of an aspect of the present invention, the designated area may be made to be accessible when other elements have higher Z-order values than the designated area, obscure the designated area and block immediate access to the information in the designated area. FIG. 4A illustrates a display 400 in which multiple windows with higher Z-order values (i.e., display priority) than the designated area and are open and are fully obscuring the designated area (not seen). In FIG. 4A, a window 403 and a Windows Media Player video clip window 402 are open on the display 400. Because the designated area (not seen) has a lower Z-order value than the Windows Media Player video clip window 402 and the window 403, the designated area lies behind the open windows (402, 403). In other words, the open windows (402, 403) completely cover the designated area which is not visible in FIG. 4A. Hence, a user would not have immediate access to information in the designated area in this case. FIG. 4B illustrates the designated area 401 situated in front of the windows (402, 403). The designated area 401 has been assigned a higher Z-order value and has consequently been brought to the front of the display 400 such that the designated area 401 now lies in front of the other windows (402, 403) that are open on the display 400. The other windows (402, 403) now have lower Z-order values than the designated area and therefore do not have display priority over the designated area. In this example, the user may now access information in the designated area 401 while other windows are open on the display 400.

Changing the Z-order value of the designated area and bringing the designated area 401 to the front of the display 400 provides fast access to the information or information source interfaces contained in the designated area 401 even if other elements on the display would have higher Z-order values and would obscure the designated area. Achieving fast access to the designated area 401, for example, by changing the relative Z-order values between the designated area and other superimposing or overlapping display elements such as other windows may be accomplished in many ways. For example, a command to change the Z-order value and to display the designated area in front of the other display elements may be received. Examples of commands to change the Z-order value and to display the designated area in front of the other display elements include but are not limited to moving a cursor or hovering a cursor over a predetermined location on the display to bring the designated area to the front of the display; selecting a button, icon or other graphic such that selection of the graphic (e.g., clicking the graphic) may result in increasing the Z-order value of the designated area and bringing the designated area to the front of the display; selecting a command from a menu, the menu being display, for example, by right clicking or by pull-down menus; or inputting a predetermined keyboard stroke or any predetermined combination of keyboard strokes. However, the present invention is not limited to any particular method of command for bringing a display element to the front of a display as any method may be used in the present invention.

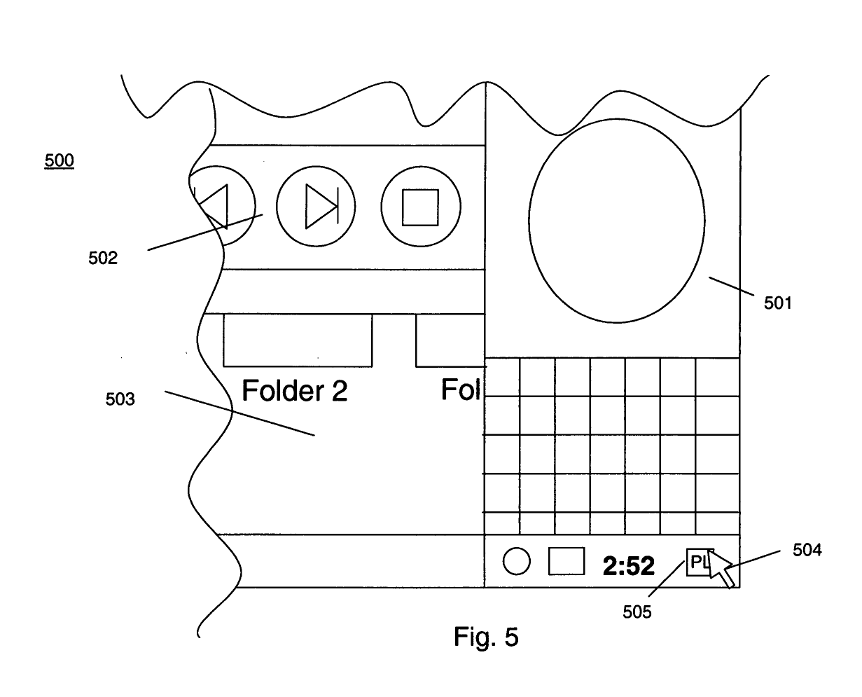

FIG. 5 is an enlarged view of the bottom right corner of the display of FIGS. 4A and 4B and illustrates one example of a method of changing the Z-order value of the designated area and bringing the designated area to the front of the display. In this example, the command to display the designated area in front of the other display elements is provided by moving or hovering a cursor over a predetermined location. As FIG. 5 illustrates, the cursor 504 is moved to a predetermined location 505 on the display (illustrated as “PL” in FIG. 5). When the cursor is placed over the predetermined location 505, the Z-order value of the designated area 501 is increased to a value that is higher than other overlapping display elements. Thus, the designated area 501 is brought to the front of the display 500 and becomes situated in front of other elements on the display 500. In this case, the Z-order value of the designated area 501 is set higher than the Z-order value of the window 503 and the Windows Media Player video clip window 502. As a result, the designated area 501 is brought in front of the window 503 and the Windows Media Player video clip window 502 as illustrated. In this example, the predetermined location 505 on the display 500 is at the lower right-hand corner of the display and is a specifically marked portion of the display 500 (e.g., a taskbar icon, a control icon, etc.) or a button on the designated area that causes the designated area 501 to be brought to the front of the display 500 when the cursor rests in front of that portion of the display 500. However, the predetermined location may also be an area on the display that changes the Z-order value of the designated area 501 and causes the designated area 501 to be brought to the front of the display 500 but is not itself a visually demarcated area. However, even if the predetermined location is not visually demarcated, the area may still function in a similar fashion to bring the designated area 501 to the front of the display 500.

In one preferred embodiment, the predetermined location 504 is smaller than the width and height of the display. As illustrated in FIGS. 4A, 4B and 5, the predetermined location 504 is smaller than the width and height of the display 400. In this example, the greatest dimension of the predetermined location is substantially less than the width and the height of the display 400. Because of the sizing of the predetermined location, a user may avoid changing the Z-order value of the designated area by accident by inadvertently passing the cursor over a large area of the display. For example, if the predetermined location were to be at a horizontal edge of the display 400 and span the entire width of the display 400, then if the cursor were to be place anywhere along the horizontal edge of the display 400, the Z-order value of the designated area would be accidentally altered (increased) causing the unwanted display of the designated area in front of other display elements.

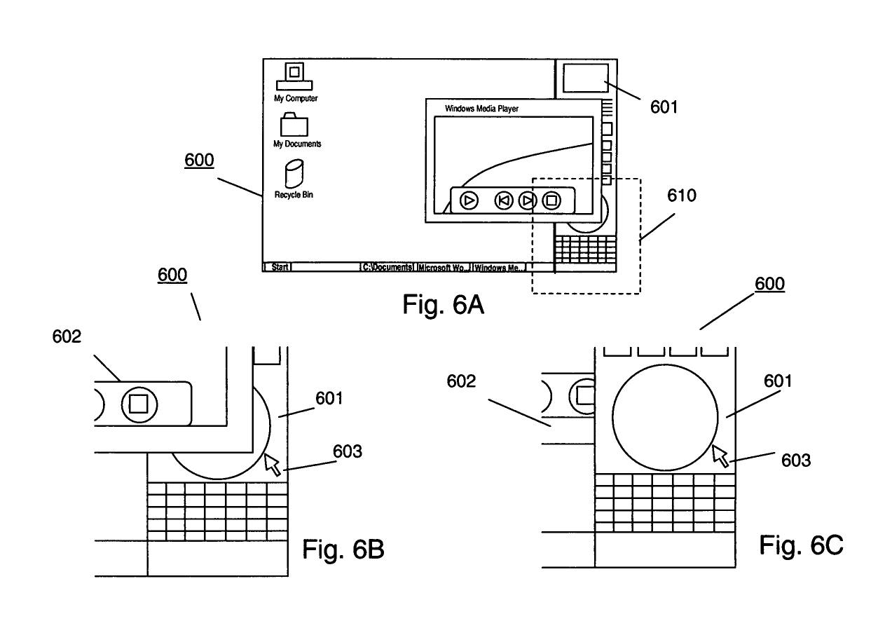

FIGS. 6A-6C illustrate an example of an alternative method of achieving fast access to a designated area on a display when the designated area is partially obscured by a display element such as a window. In this example, the command to change the Z-order value of the designated area and to display the designated area in front of other display elements is activating a cursor over a portion of the designated area. FIG. 6A shows a display 600 in which a window (in this case, a Windows Media Player video clip window) 602 partially obscures the designated area 601. Therefore, the Z-order value of the Windows Media Player video clip window 602 is higher than that of the designated area. FIGS. 6B and 6C are enlarged views of the lower right hand corner of the display illustrated in FIG. 6A (indicated by the dotted box 610). FIG. 6B shows a cursor 603 placed over a portion of the designated area 601 that is not covered by the window 602. After the cursor 603 is placed over the designated area 601 and an input device (not shown) is activated (e.g., pressing a mouse button), the Z-order value of the designated area is altered (i.e., increased) to a value that is higher than the Z-order value of the window 602. Thus, the designated area 601 is brought to the front and is now placed in front of the window 602 (FIG. 6C). The information or information source interfaces, including dynamic information, contained in the designated area 601 is now easily and conveniently accessible by the user as illustrated in FIG. 6C. Thus, the designated area 601 may be brought to the front of the display 600 when the cursor 603 is placed over an exposed portion of the designated area 601 and an input device (not shown) is activated (e.g., a mouse button is clicked). The other display elements are otherwise unaffected by placing the designated area 601 in front.

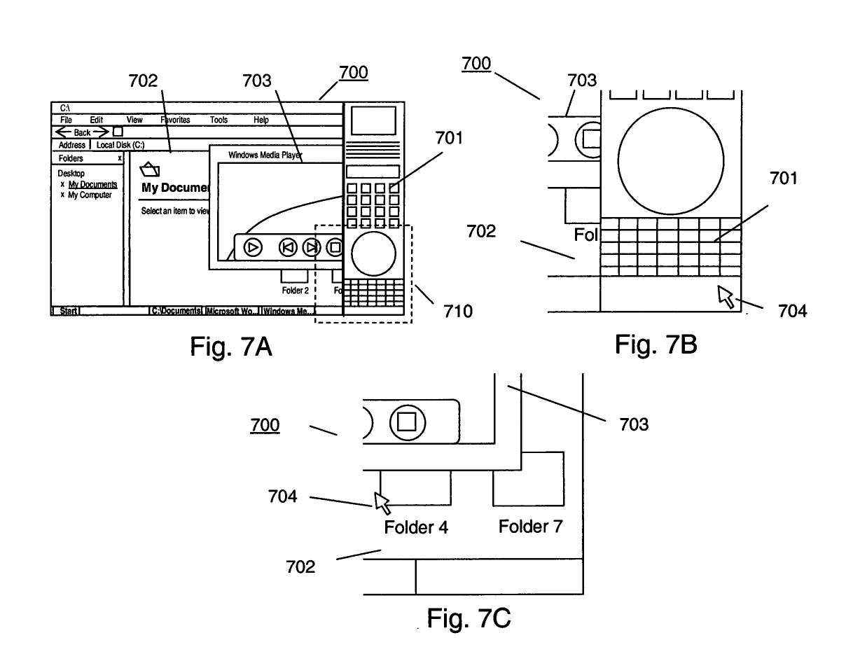

When the designated area overlies other elements on the display as is illustrated in FIGS. 7A-7C, the user may easily and conveniently access the information in the designated area 701. However, when the user does not desire access to the information in the designated area 701, the designated area 701 may be placed out of the way in order to free up space on the display for other work items. FIGS. 7A-7C illustrate an example of an aspect of the invention in which the designated area 701 is dismissed such that the space on the display occupied by the designated area 701 is available for other use. In this example, a command for dismissing the designated area is received. “Dismissing” the designated area may be accomplished by changing the Z-order value of the designated area relative to the Z-order values of other display elements. A designated area may initially have a higher Z-order value than other display elements and be displayed in front of the other display elements. However, a command may be received causing the Z-order value of the designated area to decrease to a value that is lower than that of the other display elements. If such a change in the Z-order value of the designated area occurs, the designated area, although still displayed on the display, will nevertheless be at least partially obscured by the overlapping display elements (e.g., windows) with higher Z-order values. Hence, the command may cause the designated area to be “dismissed” by adjusting the relative Z-order value (i.e., display priority). This command for dismissing the designated area may be moving a cursor away from a predetermined location or the designated area or clicking in a particular area of the display.

FIG. 7A shows a display 700 in which the designated area 701 is brought to the front of the display (i.e., the Z-order value of the designated area 701 is increased). The designated area 701 overlaps and lies in front of other open windows in the display (window 702 and Windows Media Player window 703 in this example) that have lower Z-order values than the designated area 701. FIG. 7B is an enlarged view of the area of the display indicated by a dotted box 710 in FIG. 7A. FIG. 7B shows the cursor 704 placed on a predetermined location on the display 700 such that the Z-order value of the designated area 701 is increased above the value of the Z-order values of other display elements. In this example, the command to increase the value of the Z-order value of the designated area was provided by hovering the cursor 704 over the predetermined location. As a result, the designated area 701 has been brought to the front of the display 700 and placed in front of the other windows that are open in the display (e.g., window 702 and Windows Media Player window 703).

FIG. 7C shows that the cursor 704 has been moved away from the area which the designated area (not visible in FIG. 7C) occupies. As a result, the designated area (not seen in FIG. 7C) becomes hidden behind the other open windows (e.g., window 702 and Windows Media Player window 703). The present invention is not so limited as any command to dismiss the designated area may be used. As additional non-limiting examples, a button or icon can be provided where the designated area may be requested to be hidden or placed on a lower level of elements on the display (i.e., placed behind other elements, such as windows, on a display), a selection from a menu, or a combination of keyboard strokes may be used.

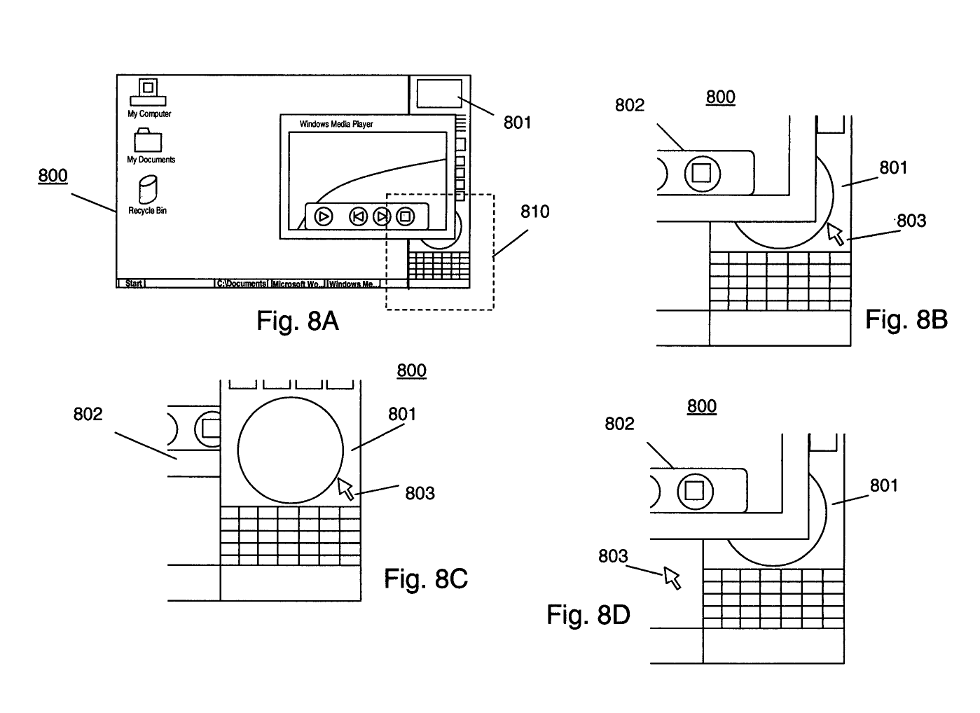

In another example, the Z-order value of the designated area is increased to display the designated area in front of other display elements by activating an input device while a cursor is over an exposed area of the designated area, then dismissed by activating an input device (e.g., clicking a mouse button) after the cursor is away from the designated area. FIG. 8A illustrates a display 800 containing a designated area 801 and a display element, i.e., a windows Media Player window 802. The designated area has a lower Z-order value than the Windows Media Player window 802. Therefore, the designated area 802 is displayed behind the Windows Media Player window 802.

FIGS. 8B, 8C and 8D illustrate an enlarged view of the lower right corner of FIG. 8A indicated by the dotted box 810. In FIG. 8B, a cursor 803 is placed over an exposed area of the designated area 801. After an input device (not shown) is activated (e.g., clicking a mouse button), the Z-order value of the designated area 801 is increased to a value higher than the Z-order value of the Windows Media Player window 802 as illustrated in FIG. 8C. In FIG. 8C, the designated area 801 now has a higher Z order than the Windows Media Player window 802 as a result of clicking the cursor in an exposed area of the designated area 801 as described.

When the designated area 801 is no longer desired, the designated area 801 in this example may be dismissed. FIG. 8D illustrates dismissal of the designated area 801. In this example, the cursor 803 is placed over a location away from the designated area 801. After the cursor 803 is placed at a location away from the designated area 801, an input device (not shown) is activated (e.g., clicking a mouse button). By clicking the cursor at a location away from the designated area 801, the Z-order value of the designated area is set to a value lower than the Z-order value of the Windows Media Player window 802. As FIG. 8D illustrates, the Windows Media Player window 802, now with a higher Z-order value than the designated area 801, is displayed in front of the designated area 801.

A user might inadvertently move a cursor over the predetermined location on the display for bringing the designated area to the front of the display. In that case, the designated area may become visible and obscure other windows. For example, FIG. 5 illustrates a cursor placed over a predetermined location on the display for bringing the designated area to the front. However, the designated area in FIG. 5 also obscures the window. The fully-accessible designated area may be desirable if the user intended to bring the designated area to the front, however, it may be desired not to have the designated area appear if there is no need to access information in the designated area.

In one aspect of the present invention, the designated area is brought to the front of the display when the cursor is placed over a predetermined location in the display after a predetermined delay elapses. Similarly, after the designated area is brought to the front of the display, the designated area is dismissed after a predetermined period of time following receiving a command to dismiss the designated area. The command to dismiss the designated area may be, for example, removal of the cursor from a location on the display in which the cursor may maintain the designated area in the front of the display. By having a delay prior to changing the status of the predetermined area after an event (e.g., placement of the cursor on the display), the predetermined area is not inadvertently activated (i.e., brought to the front) or dismissed.

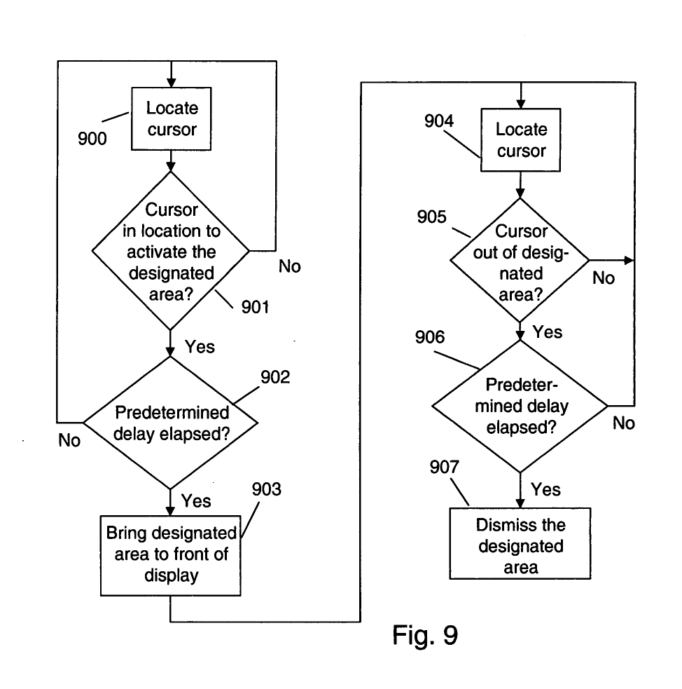

FIG. 9 illustrates an example of providing for a delay in causing the designated area to appear on the display in front of other elements on the display. In step 900, the location of the cursor is identified. The cursor location is then compared with the designated area at Step 901. If the cursor is in a location for displaying the designated area (“YES” branch of step 901), then the system waits a predetermined period of time. As long as the predetermined period of time has not elapsed (“NO” branch of step 902), the designated area will not be displayed (e.g., brought to the front of the display). If the cursor remains at the location for the predetermined period of time, the designated area is visible (“YES” branch of step 902), the designated area is brought to the front of the display at Step 903, and the user may access the information in the designated area as desired.

FIG. 9 also illustrates another aspect of the invention in which the designated area is dismissed after a delay following removal of the cursor from the location on the display for displaying the designated area. In step 904, the cursor is again located. Such location is compared to the designated area in Step 905 to see whether the cursor has been removed from the location. In this example, the location is the designated area but any desired area may be used. As long as the cursor remains at the location, the designated area remains displayed (“NO” branch of step 905). If the cursor is removed from the location (“YES” branch of step 905), it is determined if a predetermined period of time has elapsed prior to dismissing the designated area (step 906). If the predetermined period of time has not elapsed and the cursor does not remain away from the location, then the designated area remains displayed (“NO” branch of step 906). However, if the cursor remains away from the location for the predetermined period of time (“YES” branch of step 906), then the designated area is dismissed at step 907. The predetermined period of time prior to bringing the designated area to the front of a display may be independent of the predetermined period of time prior to dismissing the designated area. Therefore, although the predetermined period of time that the cursor is in the location to activate the designated area (step 902) may be the same as the predetermined period of time that the cursor is out of the designated area for dismissing the designated area (step 906), the two predetermined periods of time need not be the same. Thus, the designated area is displayed and dismissed only when the user intends for the designated area to be displayed or dismissed.

It is understood that aspects of the present invention can take many forms and embodiments. The embodiments shown herein are intended to illustrate rather than to limit the invention, it being appreciated that variations may be made without departing from the spirit of the scope of the invention. Although illustrative embodiments of the invention have been shown and described, a wide range of modification, change and substitution is intended in the foregoing disclosure and in some instances some features of the present invention may be employed without a corresponding use of the other features. Accordingly, it is appropriate that the appended claims be construed broadly and in a manner consistent with the scope of the invention.

We claim:

1. In a computer system with a display device, a method of displaying information on the display device:
displaying on the display device a display element, said display element having an associated first Z-order value;
displaying on the display device a user interface comprising a designated area and a predetermined location, said designated area having an associated second Z-order value and containing at least one information source interface;
receiving a command to change the second Z-order value relative to the first Z-order value, the second Z-order value being set to a higher value than the first Z-order value responsive to the command;
displaying the designated area in front of said display element on the display responsive to receiving said command to change the second Z-order value relative to the first Z-order value,
wherein after said step of displaying the designated area in front of said display element on the display, the second Z-order value is set to a value lower than the first Z-order value if a command to dismiss the designated area is received.

2. The method of claim 1 wherein the user interface is located on a side edge of the display.

3. The method of claim 1 wherein said information source interface in the designated area comprises dynamic information.

4. The method of claim 3 wherein said dynamic information is selected from the group consisting of financial information, weather information, sports information, news information, auction information and instant messenger information.

5. The method of claim 1 wherein the greatest dimension of the predetermined location is smaller than the height and width of the display.

6. The method of claim 1 wherein the command to change the second Z-order value relative to the first Z-order value comprises hovering a cursor over the predetermined location.

7. The method of claim 6 wherein said hovering comprises hovering the cursor over the predetermined location for a predetermined period of time.

8. The method of claim 6 wherein said command to dismiss the designated area comprises moving the cursor away from the designated area.

9. The method of claim 1 wherein said command to change the second Z-order value relative to the first Z-order value comprises activating said cursor over the designated area.

10. The method of claim 9 wherein said command to dismiss the designated area comprises moving the cursor away from the designated area.

11. The method of claim 9 wherein said command to dismiss the designated area further comprises receiving a signal from an input device after moving the cursor away from the designated area.

12. The method of claim 1 wherein the command to change the second Z-order value relative to the first Z-order value comprises one of receiving a menu selection or a keyboard stroke input.

13. The method of claim 12 wherein said command to dismiss the designated area comprises one of receiving a menu selection or a keyboard stroke input.

14. The method of claim 1 wherein the predetermined location is on a taskbar on the display.

15. The method of claim 1 wherein the predetermined location is a portion of the designated area.

16. A system capable of displaying information:
a display device for displaying a display element and a user interface, the display element having an associated first Z-order value and the user interface having an associated second Z-order value, the user interface comprising a designated area and a predetermined location, said designated area containing at least one information source interface;
an input for receiving a command to change the second Z-order value relative to the first Z-order value, the second Z-order value being set to a value higher than the first Z-order value;
a processor for displaying the designated area in front of said overlapping element on the display responsive to receiving said command to change the second Z-order value relative to the first Z-order value,
wherein after the designated area is displayed in front of said overlapping element on the display, the second Z-order value is set to a value lower than the first Z-order value if a command to dismiss the designated area is received.

18. A graphical user interface on a display comprising:
an information source interface comprising dynamic information; and
a predetermined location,
wherein a first Z-order value of the graphical user interface is higher than the second Z-order value of other display elements on the display if a command to set the first Z-order value higher than the second Z-order value of the other display elements is received.

19. The graphical user interface of claim 18 wherein the command to set the Z-order of the graphical user interface higher than the second Z-order value of the other display elements is selected from the group consisting of hovering a cursor over said predetermined location, receiving an input signal from an input device while a cursor is placed over the graphical user interface, receiving a menu selection, and receiving at least one keyboard stroke input.

20. The graphical user interface of claim 18 wherein the graphical user interface is displayed in front of the other display elements in response to receiving the command to set the first Z-order value of the graphical user interface higher than the second Z-order value of the other display elements.

21. The graphical user interface of claim 20 wherein the graphical user interface is displayed in front of the other display elements until a command to dismiss the graphical user interface is received.

22. The graphical user interface of claim 21 wherein the first Z-order value of the graphical user interface is set to a value lower than the second Z-order value of other display elements after the command to dismiss the graphical user interface is received.

23. The graphical user interface of claim 21 wherein the command to set the first Z-order of the graphical user interface comprises hovering a cursor over said predetermined location and the command to dismiss the graphical user interface comprises moving a cursor away from the graphical user interface.

24. The graphical user interface of claim 23 wherein the greatest dimension of the predetermined location is smaller than the height and width of the display.

25. The graphical user interface of claim 20 wherein the command to dismiss the graphical user interface comprises moving a cursor over a predetermined location and receiving a signal from an input device.

26. In a computer system with a display device, a method of displaying information on the display device comprising:
displaying on the display device a display element, said display element having an associated first Z-order value;
displaying on the display device a user interface having an associated second Z-order value and comprising a designated area and a predetermined location, said designated area containing at least one information source interface, said information source interface comprising dynamic information;
hovering a cursor over the predetermined location;
changing the second Z-order value relative to the first Z-order value responsive to said hovering such that the second Z-order value is set to a higher value than the first Z-order value;
displaying the designated area in front of said display element on the display responsive to changing the second Z-order value relative to the first Z-order value;
moving the cursor away from the designated area;
setting the second Z-order value to a value lower than the first Z-order value responsive to said moving;
displaying the designated area behind said overlapping element on the display responsive to setting the second Z-order value to a value lower than the first Z-order value.
